(19) United States
(12) Patent Application Publication
(10) Pub. No.: US 2005/0055668 A1
(43) Pub. Date: Mar. 10, 2005

(54) Cpl editor

(76) Inventors: Oliver Becker, Berlin (DE); Giovanni Benini, Watertown, MA (US)

Correspondence Address: Siemens Corporation;Intellectual Property Department, 170 Wood Avenue South, Iselin, NJ, 08830, US

(21) Appl. No.: 10/498,078

(22) PCT Filed: Dec. 11, 2002
(86) PCT No.: PCT/DE02/04533

(30) Foreign Application Priority Data
Dec. 14, 2001 (DE) 101 61 552.3

(51) Int. Cl. G06F 9/44

(52) U.S. Cl. 717/114

(57) ABSTRACT

The inventive system comprises a graphic interface and a converter translating the graphic symbols entered by the user into a CPL script. The generated CPL script is fed into a CPL engine for controlling various IP based services. Not only the service to be executed, but also a definition of the semantics of the individual linguistic elements are enclosed via the converter.

### CROSS REFERENCE TO RELATED APPLICATIONS

This application is the US National Stage of International Application No. PCT/DE02/04533, filed Dec. 11, 2002 and claims the benefit thereof. The International Application claims the benefit of German application No. 10161552.3 filed Dec. 14, 2001, both of the applications are incorporated by reference herein in their entirety.

### FIELD OF INVENTION

The invention relates to a method and a system consisting of a graphical interface and a converter which translates the graphical symbols into a CPL code, the CPL code which is generated being fed to a so-called CPL engine to control various IP-based services.

### BACKGROUND OF INVENTION

The general background to the present invention is the desire, in the context of “Voice over IP”, to be able to develop and implement new services simply and rapidly. An example of such a service might be that during a certain time calls incoming to the office from the most important customers are automatically redirected to a mobile telephone.

For this purpose the standardization committee, the Internet Engineering Task Force (IETF), has introduced a separate language, the Call Processing Language (CPL). CPL is a language for specifying and controlling Internet telephone applications. It is independent of the platform and system, and is based on XML. Its specification includes a grammar (DTD, Document Type Definition) which defines the syntax of the CPL elements. The DTD sets out the individual possible tags and attributes for an XML document. The sequence of the declarations is not critical, but they must be complete. The DTD reflects exactly the tree structure of the XML page. For the creation of the DTD to succeed, the data structure of the XML documents must therefore already be clearly defined.

A CPL script contains two types of information, namely general information and action-related information. The general information includes items of information which are required for a server to process the script correctly. Action-related information is information which determines the operations and decisions which should occur during a particular call which is handled by the server.

The semantics of the individual language elements in CPL has until now only been specified verbally. There is equally little formal definition of other incidentals and the CPL-internal systematics.

The user should if possible not need, in order to create a telephone service, first to learn the CPL syntax. It would therefore be advantageous to have a graphical interface which, in conjunction with an editor, permits a telephone service to be created in a simple way, as intuitively as possible, by means of symbols, and which from the user's graphical input automatically generates the associated CPL script. However, because the definition of CPL is inadequate the possibility cannot be excluded that the automatic generation and implementation of a service using CPL, making use of an editor and an interpreter, will not always provide unambiguous results. With the familiar definition it is quite possible for different CPL editors to supply different CPL scripts.

### SUMMARY OF INVENTION

Accordingly, the object underlying the invention is to provide a technique which, as far as possible, ensures that in setting up a telephony service by the creation and execution of a script, the results achieved are broadly unambiguous.

This object is achieved according to the invention by the characteristics of the independent claims. The dependent claims develop the central idea of the invention in a particularly advantageous way.

Central to the invention is the recognition that the script should include not only the service which is to be performed but also a definition of the semantics of the individual language elements in the script.

In accordance with a first aspect of the present invention, a system is provided for setting up a telephony service. This system has a graphical interface, and a converter which translates the graphical symbols input by the user using the graphical interface into a script. This script is then fed to an interpreter, to control the various IP-based services by means of a server. In doing this, the script contains not only the service which is to be performed, but also a definition of the semantics of the individual language elements of the script.

The semantics of the individual language elements can be specified, for example, by an XML-based definition.

New language-specification elements of this type then, in turn, form a separate language, which can be specified by means of an XML schema.

The syntactical and semantic definition can thus be linked by the use of the XML technology. Here, the semantics of the individual language elements can then be presented in a form which can be read by a person. Items of information which are of a purely help character can be integrated in various human languages into the XML-based definition of the computer language.

In accordance with a further aspect of the present invention, a CPL editor is provided, which has a graphical interface and a converter. The converter automatically translates symbols, input by means of the graphical interface, into a CPL script. When this is done, the CPL script contains not only the service which is to be performed, but also a definition of the semantics of the individual language elements of the CPL script.

In accordance with yet another aspect of the present invention, a method is provided for generating a CPL script on a CPL engine, to control various IP-based services. Here, instructions relating to an IP-based service are input by means of a graphical interface. These instructions are then automatically converted into a CPL script. Included with the CPL script in this case, apart from the service which is to be performed, is also a definition of the semantics of the individual language elements.

The invention relates further to a method for setting up a telephony service on the basis of a script which is generated in this way. The method has the additional step that the script is converted by an interpreter to control IP-based services by means of a server.

Finally, in accordance with the invention a software program is also provided which, when it runs on a computer, implements a method as set out above.

The syntax definitions can be effected in a standardized way, making consistent use of the XML technology.

The ability to extend XML permits in addition the definition of separate elements, which specify the meaning of actual language elements in the computer language. All the information from the previously purely verbal specification, relevant for the software which processes this language, can be deduced from these additional elements. Advantageously, the semantics of the individual language elements are thus in turn defined by means of XML and not, as until now, by a verbal specification. In this way one can avoid a situation in which different CPL engines, which generate software for the language, interpret the semantics in different ways.

By linking the syntactical and semantic definitions by the use of XML technology, one can achieve a complete language specification, effected with full formal consistency.

Furthermore, the new language-specification elements form a separate language, which can be unambiguously specified by means of an XML schema. In addition, extensions to the language can be simply implemented. Such an extension can be made, on the one hand, by the definition of additional language elements and, on the other hand, by the definition of further items of information necessary for the language specification. For example, the number of possible actions will be extended by defining further language elements.

By defining further items of information required for specifying the language, the modeling of the graphical information can be improved and also enhanced.

A further advantage consists in the fact that the semantics are presented in a form which it is easy for a person to read.

In addition, items of information which are exclusively of a help character can be integrated in various human languages into the XML-based definition of the computer language, thus enabling them to be processed, for example, by help systems.

One has then arrived at a comprehensive XML-based chain:
1. The language to be specified is XML-based.
2. The document which specifies the language elements semantically is XML-based.
3. The use of the XML schema means that the definition of this model (the so-called meta-model) is also XML-based.
4. All enhancements are XML-based.

The continuous tool chain ensures better consistency and can be processed at all levels using the same methods (XML).

Further features, advantages and characteristics of the present invention will now be explained in more detail, making reference to exemplary embodiments and the figures in the attached drawings.

### BRIEF DESCRIPTION OF THE DRAWING

FIG. 1 shows a network.

FIG. 2 shows the main points in the signal processing.

FIG. 3 shows a screenshot of a graphical interface.

FIG. 4 shows an XML-based tool chain.

FIG. 5 shows a language-specification element.

FIG. 6 shows a format for a language-specification element.

FIG. 7 shows the structure of the language-specification file.

### DETAILED DESCRIPTION OF INVENTION

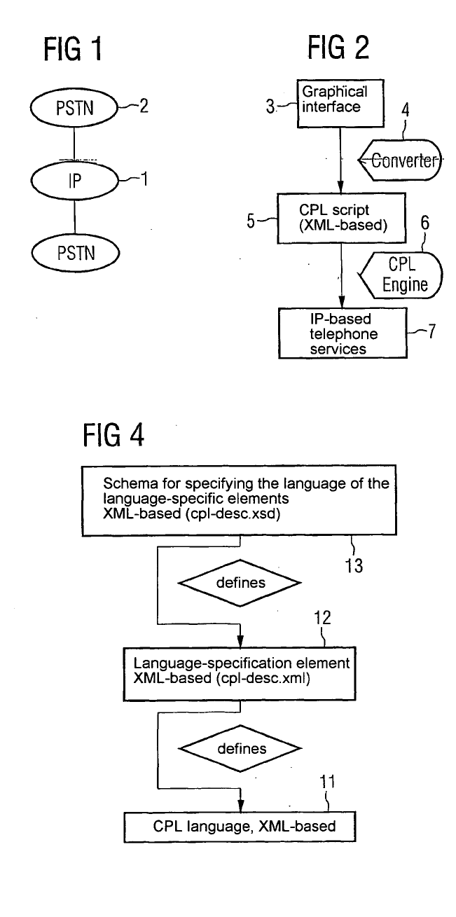

In the network shown in FIG. 1, messages which are sent over a PSTN (Public Switched Telephone Network) 1 are in addition to be put through to the receiver via a packet switched network, such as for example the Internet 2. For example, a call is to be routed to an answering machine and in addition the receiver is to be notified of the receipt of this call on another logical and/or physical channel, such as e-mail.

In order to be able to set up such a service, the user generates a CPL script 5, which is passed on to a CPL interpreter (CPL engine), which can execute services formulated in CPL. The CPL engine 6 thus executes an IP-based telephone service 7 in accordance with the CPL script generated by the user.

Here, for the creation of the CPL script the user is provided with a graphical interface (GUI) 3, which allows a service 7 to be created in a simple and intuitive manner, together with the associated script 5.

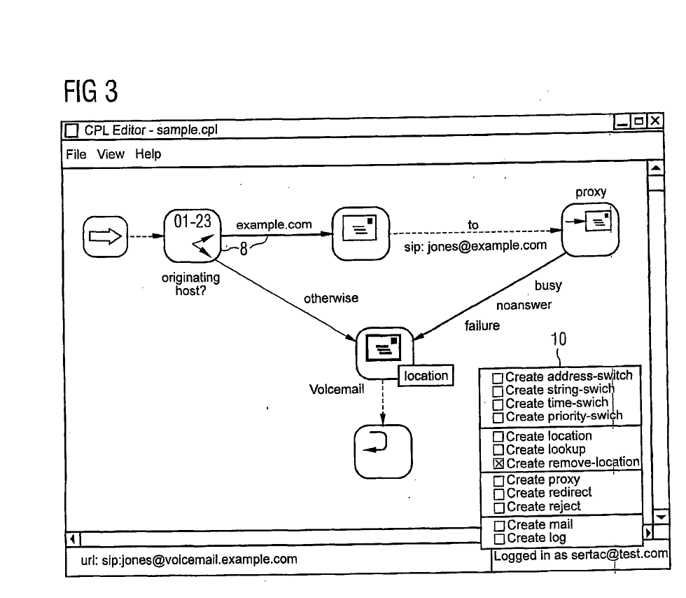

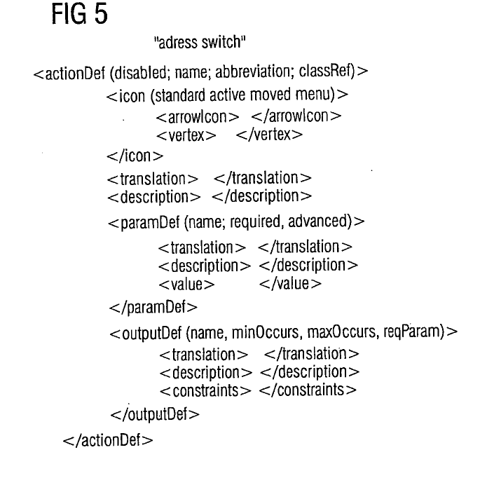

FIG. 3 shows a screenshot of a graphical interface 3. The various graphical elements 8 (the symbols and the black arrows) are converted by the editor into individual components of the CPL script 5. To be more precise, the converter 4 automatically translates the graphical symbols 8 into a CPL script 5. Parameters 9 can be input into the graphical user interface 3 via short dialogs, and then appear as comments. The various possible actions appear in a menu 10, for example when the right-hand mouse button is pressed, and from these actions the user can make a selection to create the desired CPL script 5. The user can request that the CPL script 5 which has been generated is displayed in a window of the graphical interface 3.

The services 7 generated in this way as a script are now installed and activated in a suitable way. One possibility consists in defining an LDAP (Lightweight Directory Access Protocol) structure, so that several CPL scripts 5 can be stored and activated under a user's account on one LDAP server. When required, the CPL server then loads the activated script from the LDAP server, and executes the telephone service as instructed.

(LDAP (Lightweight Directory Access Protocol) is a standardized directory service based on TCP/IP, which provides for the hierarchical administration of the most diverse classes of models in one database, and permits searches for them. The different classes (e.g. persons, documents, computer names) allow different attributes to be assigned to each class in the directory. Objects in the database are queried by means of a protocol, or appropriate gateways which can apply this protocol.)

In accordance with the invention, the definition of the meanings of the actual CPL language elements is no longer based on a verbal specification; instead the ability to extend XML is exploited to define separate elements, which specify the meaning of actual CPL language elements and are appended to the CPL script 5.

An example of such a specification can be seen in FIG. 5. For example, in order to define the action “adress-switch”, the following are defined one after another: the action, the graphical appearance (icon), the specification (description), the parameters (paramDef) and the result.

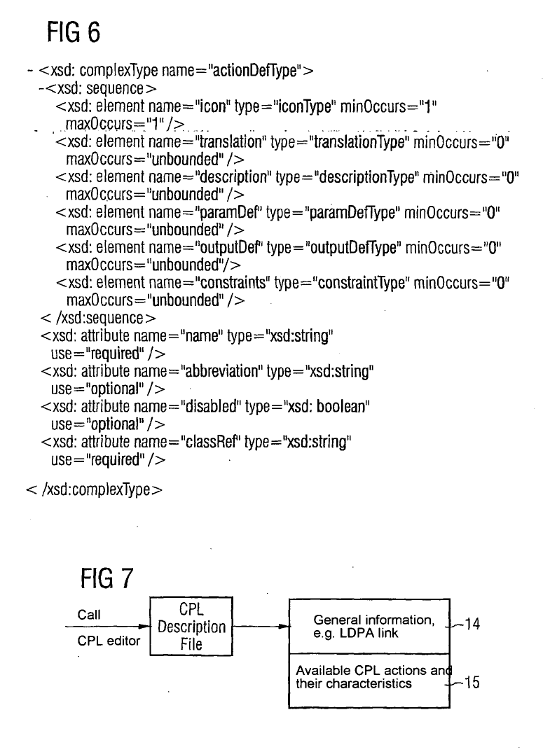

These language-specification elements form a separate language which is again specified, in its turn, by means of an XML schema. FIG. 6 shows the format for the definition of a language-specification element of the type “action”. This lays down exactly which elements must appear in the definition, and how often.

The result is then an XML-based CPL language 11. A file 12 contains the semantic definition of the language elements of the CPL language, and this is also XML-based. Finally, a schema 13 is defined, to specify the language of the language-specification elements, this also being XML-based.

This means that a complete language specification, its documentation, presentation and subsequent processing, is effected on the basis of XML.

After the graphical interface 12 has been called up, it analyzes the CPL specification file 11 syntactically. As already stated, this file contains all the information relating to the configuration of the programs. The CPL specification file consists of two parts:
1. general information 14 (for example LDAP links),
2. a specification of all the possible actions and their characteristics 15, so that the CPL converter can interpret them unambiguously.

This makes possible automatic software generation, taking into account the semantic aspects of the CPL language.

In addition, it is possible to integrate into the above-mentioned document items of information which are exclusively of a help character, in various human languages, and to create a help system which processes these items of information.

Due to the fact that the schema 13 for specifying the language of the language-specification elements is also XML-based, it is simple to implement enhancements to the language. These enhancement can be made, on the one hand, by the definition of further language elements and, on the other hand, by the definition of further items of information required for specifying the language.

1-12. (cancelled)

13. A System for setting up a telephony service, comprising:
a graphical interface;
a converter for translating graphical symbols, entered via the graphical interface, into a script;
an interpreter for controlling IP-based services, wherein
the script is fed to the interpreter, and wherein
the script comprises the service which is to be executed and a definition of the semantics of the individual language elements of the script.

14. The System according to claim 13, wherein the semantics of the individual language elements are specified by an XML-based definition.

15. The System according to claim 13, wherein the new language-specification elements form a separate language which is specified by an XML scheme.

16. The System according to claim 13, wherein the syntactical and semantic definitions are linked by XML technology.

17. The System according to claim 13, wherein the semantics of the individual language elements are presented in a form which is readable for a person.

18. The System according to claim 13, wherein items of information are purely of a help character and are integrated in a plurality of human languages into the XML-based definition of the computer language.

19. A CPL editor, comprising:
a graphical interface; and
a converter for automatically translating graphical symbols into a CPL script, wherein
the CPL script comprises the service which is to be executed and a definition of the semantics of the individual language elements of the CPL script.

20. A Method for generating a CPL script for a CPL engine, to control various IP-based services, the method comprising:
receiving input instructions relating to an IP-based service via a graphical interface; and
converting graphical symbols into a CPL script, wherein the CPL script comprises the service which is to be executed and a definition of the semantics of the individual language elements.

21. The Method according to claim 20, wherein the semantics of the individual language elements are specified by an XML-based definition.

22. The Method according to claim 20, further comprising:
integrating items of information which are of a help character in a plurality of human languages into the XML-based definition of the computer language; and
processing these items of information by a help system.

23. A Method for setting up a telephony service on the basis of a script, produced by the use of:
a CPL script generating method for generating a CPL script for a CPL engine, to control various IP-based services, wherein the CPL script generating method comprising:
receiving instructions relating to an IP-based service via a graphical interface; and
converting graphical symbols into a CPL script, wherein
the CPL script comprising the service which is to be executed and a definition of the semantics of the individual language elements;
the method for setting up a telephony service comprising:
converting the script by an interpreter for use in controlling IP-based services.

24. The Method according to claim 23, wherein the method is implemented by a Software program.
